(19) United States
(12) Patent Application Publication
(10) Pub. No.: US 2019/0179878 A1
(43) Pub. Date: Jun. 13, 2019

(54) GENERATING ORGANIZATION-SPECIFIC TAGS FOR COMMUNICATIONS FROM VARIOUS SOURCES OF AN ORGANIZATION USING AN EXPANDED KNOWLEDGE GRAPH FOR ORGANIZATION-SPECIFIC CONTENT

(71) Applicant: Google LLC, Mountain View, CA (US)

(72) Inventors: Tim Collins, San Francisco, CA (US); David Conway, Los Altos, CA (US)

(21) Appl. No.: 15/839,765

(22) Filed: Dec. 12, 2017

(51) Int. Cl. G06F 17/21; G06N 5/02; G06F 17/27; G06F 17/30

(52) U.S. Cl. CPC G06F 17/218; G06N 5/02; G06F 17/30864; G06F 17/30663; G06F 17/2735

(57) ABSTRACT

A method for expanding a knowledge graph covering organization-specific content provided by a content management platform includes identifying a knowledge graph comprising a plurality of nodes representing a plurality of defined terms, scanning a plurality of communications from a plurality of sources of an organization to identify a plurality of frequently appearing terms, determining which of the plurality of frequently appearing terms are not included in the plurality of defined terms of the knowledge graph to produce a set of undefined frequently appearing terms, prompting one or more members of the organization to provide a definition for each undefined frequently appearing term from the set of undefined frequently appearing terms, wherein the prompting occurs without a user input, and expanding the knowledge graph by adding one or more undefined frequently appearing terms, each having a provided definition, to the knowledge graph.

### BACKGROUND

Tags play an important role in knowledge management of an organization. The tags are used to capture insights, expertise, or relationships associated with information from a data source of the organization. They may add context and meaning to the information to enable proper sharing of the information across the organization.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for expanding a knowledge graph covering organization-specific content. The knowledge graph may have nodes representing terms with a definition. Communications from sources of an organization may be scanned to identify a frequently appearing terms. By referring to the knowledge graph, frequently appearing terms that are not included in the defined terms of the knowledge graph may be identified to produce a set of undefined frequently appearing terms. Members of the organization may be prompted to provide a definition for each undefined frequently appearing term, without a user input. Once the members provide a definition, the knowledge graph may be expanded by adding the undefined frequently appearing terms with the provided definition.

In some other implementations, a system and method are disclosed for generating a tag for communications from various sources of the organization using the expanded knowledge graph of the organization-specific content. A new communication of a member of the organization may be detected. In an implementation, using the expanded knowledge graph, terms that may be relevant to the new communication may be determined. The member associated with the new communication may be suggested one or more terms for a tag for an approval. The terms may be determined from the expanded knowledge graph. In response to the member approving the tag, the tag may be assigned to the new communication.

In some other implementations, a system and method are disclosed for notifying members of the organization a new communication that may be interesting or relevant. In an implementation, the approved tag of the new communication may be matched with profile attributes of members other than the member from whom the new communication is originated to identify members who may be interested in being notified of the new communication. Once members are identified, a notification of the new communication may be sent to each member identified.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture for implementations of the present disclosure.

FIG. 2 illustrates a flow diagram of a method for expanding a knowledge graph, in accordance with some aspects of the disclosure.

FIG. 3 depicts a flow diagram of a method for generating a tag for a communication using an expanded knowledge graph, in accordance with some aspects of the disclosure.

FIG. 4 illustrates a flow diagram of a method for sending a notification of a new communication based on a tag of the new communication and profile attributes of members in accordance with some aspects of the disclosure.

FIG. 5 depicts a block diagram of an example computing system operating in accordance with one or more aspects of the present disclosure.

### DETAILED DESCRIPTION

Content management platform of an organization may provide file storage and services (e.g., document services (e.g., word processor, presentation, and spreadsheet applications), a cloud-based document storage service, an online calendar service, an email service, a messenger, etc.) to members of the organization, among other things. For example, the content management platform may enable members of the organization to collaborate and/or communicate with each other. An organization used herein may refer to a private, public, nonprofit organizations, or teams having a group of people. As members of the organization collaborate using services offered by the content based platform, organizational knowledge may be created. However, such knowledge may be lost if not shared with other members of the organization, and/or such knowledge may be underutilized if collaboration content is not shared with proper members of the organization (with members who have interest in the collaboration content).

Aspects and implementations of the present disclosure address the above deficiencies, among others, by expanding a knowledge graph covering organization-specific content and using the expanded knowledge graph in generating a tag to organizational knowledge. A knowledge graph of an organization may represent a dictionary of terms within a specific industry, topic, product or service area. In order to preserve knowledge within the organization, communications (e.g., documents (e.g., a slide presentation, a text document, a spreadsheet), comments to the documents, social posts, search queries, and emails) from various sources of the organization that are generated from the services provided by the content management platform, may be scanned to identify frequently appearing terms in the communications. Then, the frequently appearing terms may be matched with the knowledge graph to determine terms that are not included in the defined terms of the knowledge graph. Certain members of the organization may be prompted to provide a definition for such undefined frequently appearing terms. The members being prompted may be determined based on their profile attributes (e.g., areas of expertise, interests, affinities), history of providing a definition to a term, responsiveness to communications. Once a member provides a definition, the knowledge graph may be expanded by adding the undefined frequently appearing terms to the knowledge graph with the provided definition. As such, the knowledge graph may be expanded to fill in any missing knowledge of the organization and further used to generate a tag in order to manage knowledge within the organization.

In addition or alternatively, a tag for a communication of a member may be generated and suggested to the member. In implementations, any new communication may be detected and one or more terms that are relevant to the new communication may be determined based on content of the new communication and/or profile attributes (e.g., interests, expertise, affinities) of members associated with the new communication. A tag may be generated including the determined terms and suggested to the member of the new communication. The member may approve or decline the tag. In case the member approves the tag, the tag may be assigned to the new communication for future references. In this way, the new communication may be categorized and searchable based on the tag to avoid losing any knowledge contained in the new communication.

In addition or alternatively, a notification of a new communication may be sent to a member who may be interested in information contained in the new communication or to whom the information contained in the new communication may be relevant (e.g., due to the member's position, assigned tasks, etc.), thereby propagating knowledge across the organization. An assigned tag of the new communication may be matched with profile attributes (e.g., interests, expertise, affinities) of members of the organization to identify one or more members who may be interested in the new communication. Once the members are identified, a notification of the new communication may be sent to the identified members. Such matching of the tag and profile attributes would help sharing knowledge with the appropriate members of the organization. Accordingly, aspects of the present disclosure improve knowledge management of the organization via the content management platform.

Some benefits of the present disclosure may provide a technical effect caused by and/or resulting from a technical solution to a technical problem. For example, one technical problem may relate to a large amount of processing resources (e.g., processing device, memory) required when building and expanding a knowledge graph by searching various sources for definitions and reconciling different definitions of the same term (e.g., a definition of “bridge” in the area of construction versus the dental practice. One of the technical solutions to the technical problem may include scanning communications from sources of the organization to identify terms that should be included in a knowledge graph and prompting members of the organization to provide a definition for the identified terms in order to expand the knowledge graph. By sourcing the definition from members of the organization, the accuracy of the definitions and their relevancy to the organization are improved, and load on processing resources is reduced resulting in more efficient usage of computing resources.

Another example of a technical problem may relate to expensive processing resources in automatically generating tags for categorization of knowledge within contents of the communications (e.g., documents (e.g., a slide presentation, a text document, a spreadsheet), comments to the documents, social posts, search queries, and emails). One technical solution may be using a tag approved by a member who generated the new communication. In implementations, one or more terms that are relevant to the new communication as a tag may be determined based on a knowledge graph and proposed to the member for approval to be assigned to the new communication. As a result, by utilizing member's experience and knowledge in accurately selecting a term for the tag, the processing resources may be saved by reducing memory consumption and processing power when managing knowledge for the organization.

Another example of a technical problem may relate to a waste of processing resources by routing a notification of a new communication to members who may not be interested in knowing the information. As an exemplary technical solution, a tag of a new communication may be matched with profile attributes such as interests, expertise, or affinities of members of the organization so that the new communication may be send to members who are likely to be interested in information of the new communication. Such technical solution enables efficient use of processing resources and reduces memory consumption.

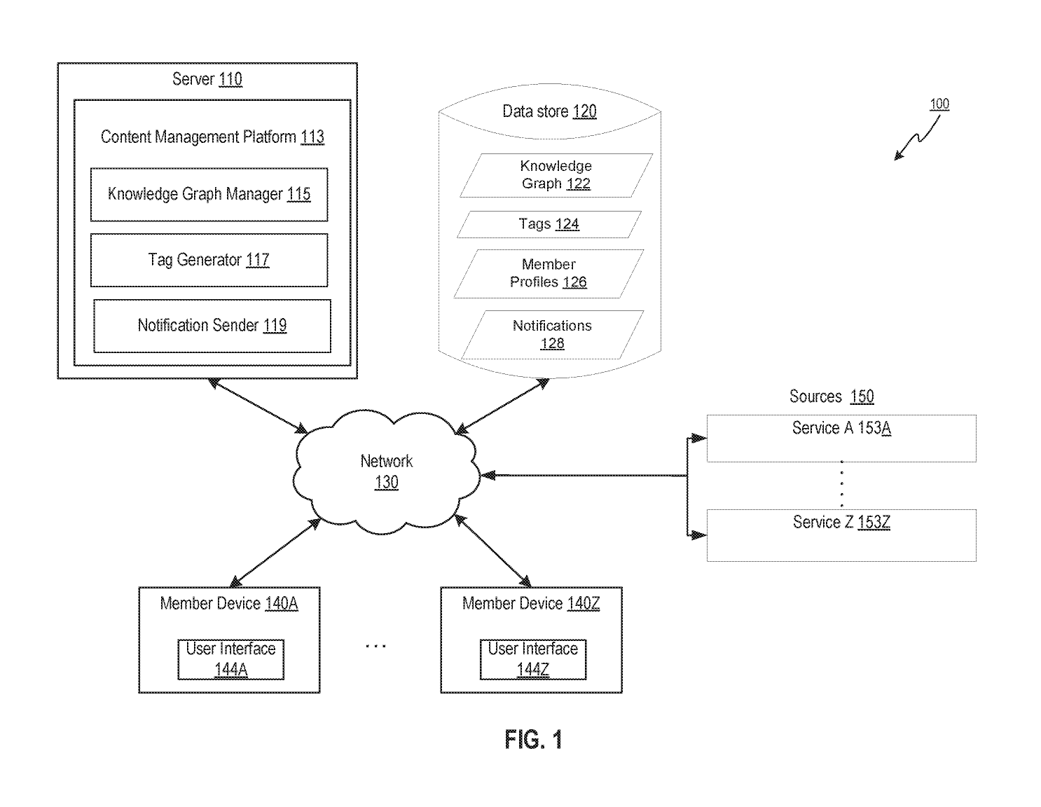

FIG. 1 illustrates an example of a system architecture 100 for an organization for implementations of the present disclosure. The system architecture 100 includes a server 110 connected to member devices 140A-140Z, a network 130, a data store, 120, and sources 150. The server 110 may be part of a cloud-based environment which refers to a collection of physical machines that host applications providing one or more services (e.g., content management) to multiple client devices (member devices 140A-140Z) via the network 130. The network 130 may be public networks (e.g., the Internet), private networks (e.g., a local area network (LAN) or wide area network (WAN)), or a combination thereof. The network 130 may include a wireless infrastructure, which may be provided by one or more wireless communications systems, such as a wireless fidelity (WiFi) hotspot connected with the network 130 and/or a wireless carrier system that can be implemented using various data processing equipment, communication towers, etc. Additionally or alternatively, the network 130 may include a wired infrastructure (e.g., Ethernet). The system architecture 100 may include various services (e.g., a document service (e.g., word processor, presentation, and spreadsheet applications), a cloud-based storage service, a social network service, a search engine service, an email service, etc.) 153 provided over a network 130 to enable collaboration and/or communication among members of the organization via their member devices 140A-140Z.

The server 110 may be represented by one or more physical machines (e.g., server machines, desktop computers, etc.) that include one or more processing devices communicatively coupled to memory devices and input/output (I/O) devices. The server 110 may host a content management platform 113.

The content management platform 113 may be implemented as computer instructions that are executable by one or more processing devices on the server 110. In alternative implementations, the content management platform 113 may be installed on the member devices 140A-140Z (e.g., as a standalone application) and operate as peers in a peer-to-peer environment. In yet alternative implementations, applications on the member devices 140A-140Z may interact with the content management platform 113 and may perform some of the functionality of the content management platform 113.

The content management platform 113 may include or interact with various communication and collaboration services (e.g., a document service (e.g., word processor, presentation, and spreadsheet applications), a cloud-based storage service, a social network service, a search engine service, an email service, etc.) 153 provided to members of the organization via a user interface (UI) 144A-144Z. The content management platform 113 may manage a knowledge graph 122, generate a tag 124 for suggestion with regards to a new communication (e.g., documents (e.g., a slide presentation, a text document, a spreadsheet), comments to the documents, social posts, search queries, and emails) of a member based on the knowledge graph 122, and send a notification 128 to members of the organization who may be interested in receiving new communications based on a tag 124 and member profiles 126 (e.g., interests, expertise, affinities). Additionally, in some embodiments, the content management platform 113 may provide the UIs 144A-144Z to member devices 140A-140Z of the organization that enables a member to view a prompt requesting to provide a definition for a term frequently used in communications but not defined in the knowledge graph 122, to create or generate communications, to receive and approve a tag 124 suggested for a communication generated, and to receive notifications 128 of new communications that may be relevant or interesting to the member.

In an implementation, the UIs 144A-144Z of the content management platform 113 may be web pages rendered by a web browser and displayed on the member devices 140A-140Z in a web browser window. In another implementation, the UIs 144A-144Z may be displayed by a mobile application or a desktop application. For example, the UIs 144A-144Z may be displayed by a native application executing on the operating system of the member devices 140A-140Z. The native application may be separate from a web browser.

In implementations, the server 110 includes a knowledge graph manager 115, a tag generator 117, and a notification sender 119. The knowledge graph manager 115 may expand a knowledge graph 122. In some implementations, the knowledge graph manager 115 may scan communications from various sources 150 of the organization and identify frequently appearing terms that are not included and not defined in the knowledge graph 122. Then, the knowledge graph manager 115 may automatically prompt members of the organization who would have the necessary expertise to provide a definition of the undefined frequently appearing terms without any input from members. The knowledge graph manager 115 may refer to member profiles 126 to determine who to be prompted with the definition request. In response to receiving the definition from members, the knowledge graph manager 115 may expand the knowledge graph 122 by adding a new node of the term with the provided definition. In some implementations, the knowledge graph manager 115 may create the knowledge graph 122 covering organization-specific contents and store the knowledge graph 122 in data store 120.

The tag generator 117 may generate a tag 124 to be assigned to communications (e.g., documents (e.g., a slide presentation, a text document, a spreadsheet), comments to the documents, social posts, search queries, and emails) from members of the organization. In implementations, the tag generator 117 may monitor and detect a new communication of a member and determine one or more terms from a knowledge graph 122 that are relevant to the new communication. The tag generator 117 may suggest the terms as a tag 124 to the member of the new communication. In response to receiving an approval of the tag 124 from the member, the tag generator 117 may assign the tag 124 to the new communication. The tag generator 117 may store the approved tag 124 in the data store 120.

The notification sender 119 may send a notification 128 of new communications that may be of interest and relevance to members of the organization. In implementations, the notification sender 119 may match new communications (e.g., documents (e.g., a slide presentation, a text document, a spreadsheet), comments to the documents, social posts, search queries, and emails) with member profiles (e.g., interests, expertise, affinities) 126 to identify members other than the ones where the new communications are originating from and may send a notification 128 to the identified members. The notification sender 119 may compose the notification 128 having a short description about the new communications and/or a tag 124 assigned to the new communications. The notification sender 119 may store the notification 128 in data store 120.

The data store 120 may be separate from the server 110 and communicatively coupled to the server 110, or the data store 120 may be part of the server 110. In some embodiments, the data store 120 may reside on the member devices 140A-140Z. Alternatively, the data store 120 may be a distributed data store including multiple repositories, databases, etc.

The data store 120 may include a knowledge graph 122, tags 124, member profiles 126, and notifications 128. The knowledge graph 122 is a knowledge base having structured information about semantic entities (i.e., nodes in the graph) and relational connections (i.e., edges in the graph) between the semantic entities. In implementations, the knowledge graph 122 may represent a dictionary of terms specific to an industry, a topic, or a product or service area of the organization. For example, for each topic like a construction service or a dental service, the knowledge graph 122 for the construction service may have terms related to the construction service specific to the organization. The terms may be structured in a hierarchy based on semantic relationship among them. In addition, for each term in the knowledge graph 122, a definition is included in the knowledge graph 122. The definition may be included in the knowledge graph 122 as a property of a respective node. The definition may be provided by members of the organization and may be editable by the members.

Tags 124 may be terms or keywords assigned to communications (e.g., documents (e.g., a slide presentation, a text document, a spreadsheet), comments to the documents, social posts, search queries, and emails) of the organization. In implementations, tags 124 are used to describe the communications and capture a central topic or concept of the communications.

Member profiles 126 may include information about a member of the organization. In implementations, member profiles 126 may include profile attributes (e.g., areas and/or a level of expertise, interests, affinities), history of providing a definition to a term, responsiveness to communications, identity, and contact information for each member of the organization.

Notifications 128 may be a short description about new communications to be notified and indications alerting that the new communications may be interesting and relevant to a member. In some implementations, a notification 128 may include a tag 124. Notifications 128 may be sent to a member via a post in a stream, an email, or a text message.

In addition, the data store 120 may store communications from various sources 150 having collaboration and/or communication services 153A-153Z (e.g. a document service (e.g., word processor, presentation, and spreadsheet applications), a cloud-based storage service, a social network service, a search engine service, an email service, etc.). Such communications data in the data store 120 may include a variety types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.), comments to the documents, social posts, search queries, and emails. These communications may be shared amongst the members and/or concurrently editable by the members.

In some implementations, the data store 120 may include a machine learning model, a training data set, and input and output of the machine learning model. The machine learning model may be composed of, e.g., a single level of linear or non-linear operations (e.g., a support vector machine [SVM] or may be a deep network, i.e., a machine learning model that is composed of multiple levels of non-linear operations. An example of a deep network is a neural network with one or more hidden layers, and such machine learning model may be trained by, for example, adjusting weights of a neural network in accordance with a backpropagation learning algorithm or the like. For convenience, the remainder of this disclosure will refer to the implementation as a neural network, even though some implementations might employ an SVM or other type of learning machine instead of, or in addition to, a neural network. In some implementations, the machine learning model may be trained by a training engine (not shown) of the notification sender 119 and the trained machine learning model may be used by a member selector (not shown) of the notification sender 119.

The member devices 140A-140Z may include one or more processing devices communicatively coupled to memory devices and I/O devices. The member devices 140A-140Z may be desktop computers, laptop computers, tablet computers, mobile phones (e.g., smartphones), or any suitable computing device. As discussed above, the member devices 140A-140Z may each include a web browser and/or a client application (e.g., a mobile application or a desktop application). A member may generate, access, or respond to communications via the web browser or the client application. For example, a member may compose an email and respond to a request to provide a definition of a term used in the email. In another example, another member may create a word document and upon sharing the document, be prompted with a suggested tag 124 for the document, and approve or decline the suggestion. Also, another member may receive in a stream, a new post notifying the member of the other member's email that may be relevant or interesting. The post may provide a link to access the other member's email.

Sources 150 can be data sources that provide communications (e.g., documents (e.g., a slide presentation, a text document, a spreadsheet), comments to the documents, social posts, search queries, and emails) from various services 153A-153Z. Services 153A-153Z may be provided to the organization via a subscription for collaboration and/or communication among members of the organization. Examples of services include a document service (e.g., word processor, presentation, and spreadsheet applications), a cloud-based storage service, a social network service, an email service, a calendar service, a search engine service, a video conference service, a media streaming service, a news providing service, and a photo management service. As members of the organization use these services via the content management platform 113, the members may create, access, share, or edit communications generated by the services. For example, text documents, spreadsheet documents, presentation documents, and comments in documents may be generated via a document service. Other examples of communications may include emails, instant messages, social posts, comments, search queries, voice or video calls, videos, songs, calendar invitations, and photographs.

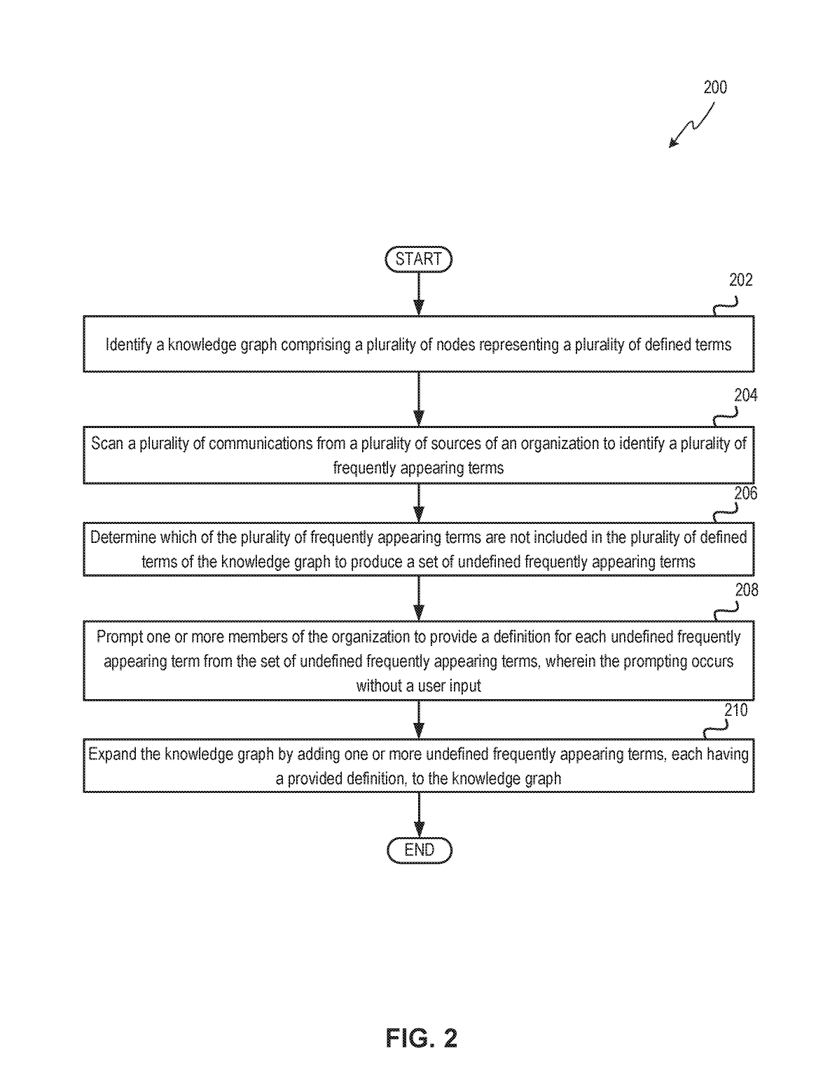

FIG. 2 illustrates a flow diagram of a method for expanding a knowledge graph 122, in accordance with some aspects of the disclosure.

The method 200 may be performed by the knowledge graph manager 115 of FIG. 1. In another implementation, the method 200 may be performed by a client application executed by one or more processing devices of the server 110. The method 200 may be carried each member device 140A-140Z of the content management platform 113. Further, the method 200 may be performed when a member of the organization composes a communication via any services 153A-153Z provided to the organization. Furthermore, the method 200 may be performed by the tag generator 117 or the notification sender 119 of the content management platform 113.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 202, the knowledge graph manager 115 identifies a knowledge graph 122 having nodes representing defined terms. In some implementations, the knowledge graph 122 may represent a dictionary of terms specific to an industry, a topic, or a product or service area of the organization. For example, if the knowledge graph 122 represents a dictionary in a construction industry, a node may represent “a bridge” and has a definition, “a structure built to span physical obstacles to provide a passage over the obstacles” as a property of the node. The knowledge graph manager 115 may create the knowledge graph 122 based on organization-specific contents. In some other embodiments, the knowledge graph manager 115 may access or download a generic knowledge graph 122 from any sources 150 of the organization. The generic knowledge graph 122 may be based on general public contents that are not specific to any an industry, a topic, or a product or service area of the organization.

At block 204, the knowledge graph manager 115 may scan communications from sources 150 of the organization to identify frequently appearing terms. Some examples of the plurality of sources 150 include services 153A-153Z provided to the organization for communication and collaboration among members of the organization. The services may include, for example, a document service, a cloud-based storage service, a social network service, an email service, a calendar service, a search engine service, a video conference service, a media streaming service, a news providing service, and a photo management service.

The knowledge graph manager 115 may scan communications (e.g., documents (e.g., a slide presentation, a text document, a spreadsheet), comments to the documents, social posts, search queries, and emails) generated via such sources 150. For example, the knowledge graph manager 115 may parse through text documents, spreadsheet documents, presentation documents, emails, instant messages, social posts, comments, search queries, voice or video calls, videos, songs, calendar invitations, or photographs. During the scanning of the communications, the knowledge graph manager 115 may identify frequently appearing terms. In some implementations, the knowledge graph manager 115 may determine a frequency of a term appearing in multiple communications from multiple sources 150. Then, the knowledge graph manager 115 may determine a number of sources 150 the term appears in. In one implementation, the number of sources 150 may be the same as a number of different services 153A-153Z the term appears in. The knowledge graph manager 115 may determine the frequency of the term and the number of sources 150 over a predefined time period. In some other embodiments, the knowledge graph manager 115 may determine a number of communications of the sources 150 instead of or in furtherance of determining the number of sources 150.

Based on the frequency and the number of sources 150, the knowledge graph manager 115 may calculate a frequency score of the term. In some implementations, when calculating the frequency score of the term, the knowledge graph manager 115 may multiply the frequency of the term by a first weight, multiply the number of sources 150 by a second weight, and add the weighted value of the frequency of the term and of the number of sources 150 to determine the frequency score.

In one implementation, the knowledge graph manager 115 may identify frequently appearing terms that are semantically significant. Thus, the knowledge graph manager 115 may further incorporate a level of semantic relevance of the term to each respective communication in the frequency score calculation. The level of semantic relevance may be represented by a numerical value between 0 and 1. The level of semantic relevance of a term may indicate how significant the term is in understanding content and intent of a respective communication. In one example, terms that are included in a title of a document or subject of an email may be considered to have a higher level of semantic relevance than terms only included in content of the document or the email and not included in the title or subject. In another example, the level of semantic relevance of the term may be determined using a word mover's distance (WMD) between the term in a communication and a term of the knowledge graph 122. The WMD may indicate a level of similarity or dissimilarity between the two terms. The term in the communication may be bigrams or trigrams. In order to calculate the frequency score of the term, the knowledge graph manager 115 may adjust the first weight on the frequency of the term in proportion to the level of semantic relevance of the term. Additionally, the knowledge graph manager 115 may factor in a number of members using the term in the communications to the frequency score. Moreover, the knowledge graph manager 115 may determine a number of members who uses the term and who are experts in an area the term belongs to and/or who are experts in an area the knowledge graph 122 represents the dictionary from, based on profile attributes 126 of members. In calculating the frequency score of the term, the knowledge graph manager 115 may adjust the second weight on the number of sources 150 in proportion to the number of members using the term in the communications.

Once the frequency score of the term is calculated, the knowledge graph manager 115 may compare the frequency score against a predetermined threshold score. If the frequency score is above the predetermined threshold score, the knowledge graph manager 115 may identify the term as a frequently appearing term.

After scanning the communications from the sources 150 to identify frequently appearing terms, the knowledge graph manager 115, at block 206, determines which of the frequently appearing terms are not included in the defined terms of the knowledge graph 122 to produce a set of undefined frequently appearing terms. In one implementation, the knowledge graph manager 115 may match each frequently appearing term against nodes of the knowledge graph 122 and identify frequently appearing terms that does not have matching nodes. In this way, the knowledge graph manager 115 can identify a node that is likely to be missing and thus, that need to be added in the knowledge graph 122.

At block 208, the knowledge graph manager 115 may prompt one or more members of the organization to provide a definition for each undefined frequently appearing term from the set of undefined frequently appearing terms. The knowledge graph manager 115 may prompt the members without any user input. In order to prompt the members to provide the definition, the knowledge graph manager 115 may identify one or more members based on one or more of expertise, responsiveness, or history of providing definitions of a member. That is, the knowledge graph manager 115 may select members who is likely to respond and to provide a well-informed definition. Once members to be prompted have been identified, the knowledge graph manager 115 sends a request to provide a definition to each undefined frequently appearing term to the identified members of the organization. In some implementations, the knowledge graph manager 115 may send a request to provide a definition for a predetermined number of the undefined frequently appearing terms.

In some implementations, the knowledge graph manager 115 may send the request for definition by monitoring communications of the identified members of the organization via the sources 150 of the organization to detect any terms in the set of undefined frequently appearing terms. Responsive to detecting a term in the monitored communications, the knowledge graph manager 115 may highlight the term in the communications and prompt a respective member who is associated (e.g. composer, reviewer, editor) with the communications containing the term to provide a definition of the term. In some other implementations, the knowledge graph manager 115 may send the request for definition by adding a post with a question about a definition of each undefined frequently appearing term to a stream of identified members on a periodic basis.

In response to receiving a requested definition of undefined frequently appearing terms from members, the knowledge graph manager 115, at block 210, expands the knowledge graph 122 by adding one or more undefined frequently appearing terms, each having a provided definition, to the knowledge graph 122. In some implementations, each undefined frequently appearing term is added as a node to the knowledge graph 122 with the provided definition as a property of the node.

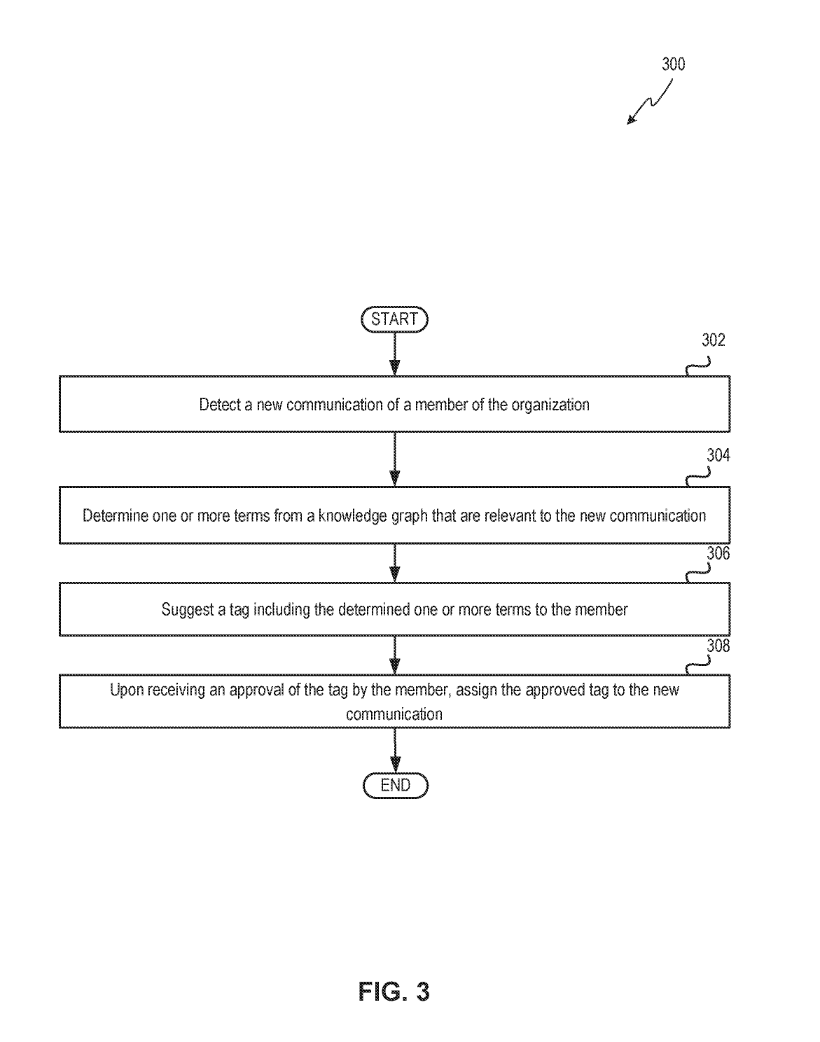

FIG. 3 depicts a flow diagram of a method for generating a tag 124 for a communication using an expanded knowledge graph 122, in accordance with some aspects of the disclosure.

The method 300 may be performed by the tag generator 117 of FIG. 1. In another implementation, the method 300 may be performed by a client application executed by one or more processing devices of the server 110. The method 300 may be carried out for each member device 140A-140Z of the content management platform 113. Further, the method 300 may be performed when a member of the organization composes a communication via any services 153A-153Z provided to the organization. In some other implementations, the method 300 may be carried out after the method 200 is performed. Furthermore, the method 300 may be performed by the knowledge graph manager 115 or the notification sender 119 of the content management platform 113.

At block 302, the tag generator 117 may detect a new communication (e.g. a new document, a new comment in a document, a new social post, a new search query, etc.) of a member of the organization via various sources 150 of the organization.

At block 304, the tag generator 117 may determine one or more terms from a knowledge graph 122 that are relevant to the new communication. In some implementations, the knowledge graph 122 may be the expanded knowledge graph 122 at block 210 of the method 200. The tag generator 117 may determine terms from the knowledge graph 122 that may be relevant to the new communication based on a content of the new communication. In order to determine which terms in the knowledge graph 122 are relevant to the new communication, the tag generator 117 may determine a level of topicality of each term in the content of the new communication using the knowledge graph 122. The level of topicality of the term may indicate semantic relevance of the term to the new communication. If a term, “bridge” in the new communication has a level of topicality of 90%, the level indicates that there is a 90% chance that the most topical thing in content of the new communication is the “bridge.” The tag generator 117 may rank terms of the new communication based on the level of topicality and may select one or more terms above a predetermined threshold value of the level of topicality as terms that are relevant to the new communication.

In addition to determining the relevant terms of the new communication based on the content of the new communication, the tag generator 117 may further base the determination on i) one or more profile attributes 126 (e.g., interests, expertise, affinities) of the member who generated the new communication, or ii) profile attributes 126 of other members associated with the new communication. The tag generator 117 may adjust the level of topicality based on the determined profile attributes 126.

At block 306, the tag generator 117 may suggest a tag 124 including the determined one or more terms to the member who generated the new communication. The tag generator 117 may suggest the terms for the tag 124 when the member tries to insert or assign a tag to the new communication.

Once the member approves one or more terms as the tag 124 for the new communication, at block 308, the tag generator 117 may assign the approved tag 124 to the new communication.

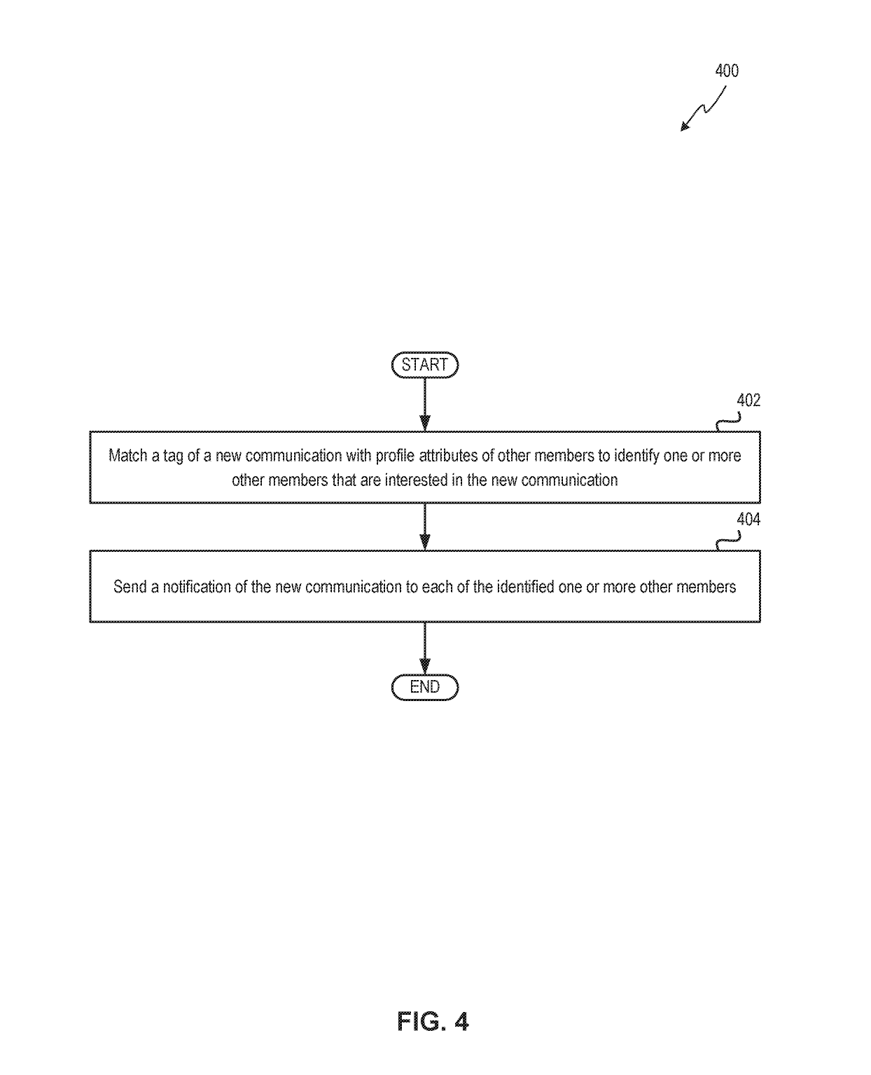

FIG. 4 illustrates a flow diagram of a method 400 for sending a notification 128 of a new communication based on a tag 124 of the new communication and profile attributes 126 of members in accordance with some aspects of the disclosure.

The method 400 may be performed by the notification sender 119 of FIG. 1. In another implementation, the method 400 may be performed by a client application executed by one or more processing devices of the server 110. The method 400 may be carried out for each member device 140A-140Z of the content management platform 113. Further, the method 400 may be performed when a member of the organization composes a communication via any services 153A-153Z provided to the organization. In some other implementations, the method 400 may be carried out after the method 300 is performed or both the methods 200 and 300 are performed. Furthermore, the method 400 may be performed by the knowledge graph manager 115 or the tag generator 117 of the content management platform 113.

At block 402, the notification sender 119 may match a tag 124 of a new communication with profile attributes 126 of members other than a member who generated the new communication to identify one or more other members that are interested in the new communication. In some implementations, the tag 124 may be the assigned tag 124 of the new communication at block 309 of the method 300. When matching the tag 124, the notification sender 119 may utilize a machine learning model. For example, the member selector of the notification sender 119 may provide the tag 124 of the new communication and profile attributes 126 of members other than the one who generated the new communication, as an input to a trained machine learning model and obtain an output from the trained machine learning model. The output of the machine learning model may indicate a level of relevancy of the new communication to a subset of other members. The level of relevancy may be represented by a probability having a numerical value between 0 and 1. The higher the probability, the more relevant the new communication is to a respective member. Accordingly, the notification sender 119 utilizes the machine learning model to predict the subset of members who may be interested to be notified of the new communication.

The notification sender 119 may train the machine learning model or the notification sender 119 may obtain the trained machine learning model from any services 153A-153Z provided to the organization. The notification sender 119 may train the machine learning by providing training data to train the machine learning model on a set of training inputs and a set of target outputs. The set of training inputs may comprise one or more of communications attributes of communications from the sources 150 of the organization, tags 124 of the respective communications, and profile attributes 126 of members of the organization and the set of target outputs may comprise an indication of whether or not a member has shown interest in the tag 124 (e.g., whether a member has tracked, subscribed, or followed the tag). The notification sender 119 may find patterns in the training data set that map the training input to the target output, and provide the machine learning model that captures these patterns. In some other implementations, the trained machine learning model may be obtained from a source 150.

At block 404, the notification sender 119 may send a notification 128 of the new communication to each of the identified members other than the member who generated the new communication. The notification sender 119 may send the notification 128 in a stream of the identified members, an email to the identified members, or a text message to the identified members.

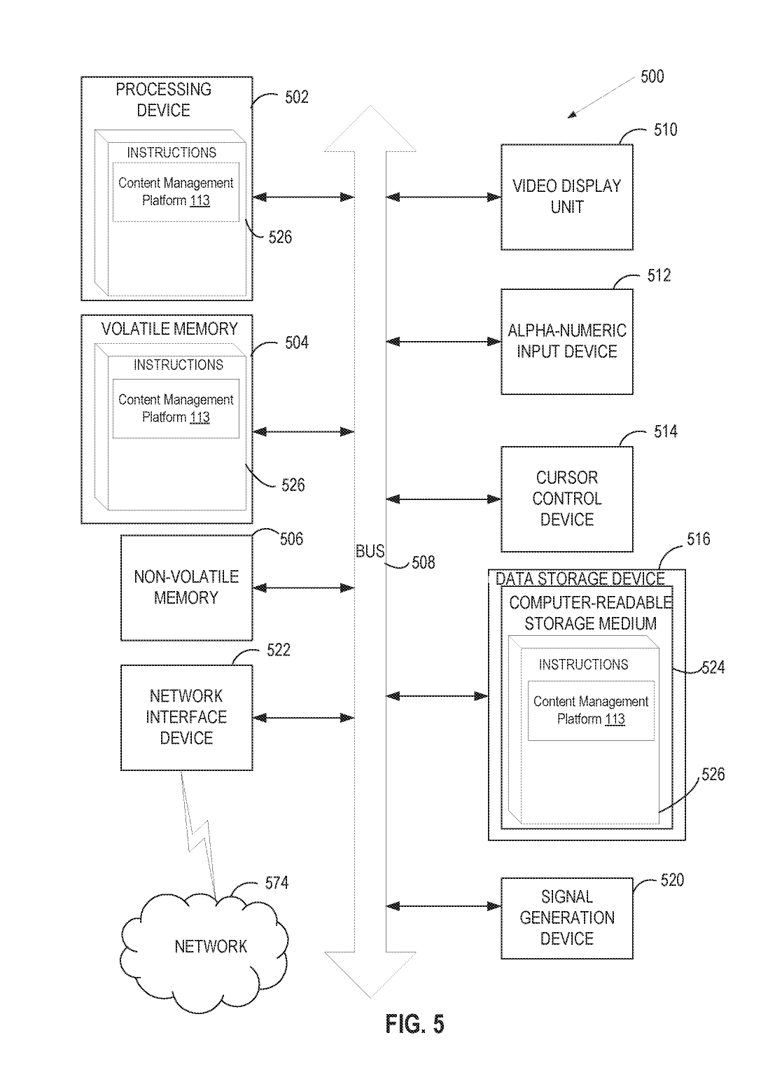

FIG. 5 depicts a block diagram of an example computing system operating in accordance with one or more aspects of the present disclosure. In various illustrative examples, computer system 500 may correspond to any of the computing devices within system architecture 100 of FIG. 1. In one implementation, the computer system 500 may be a server 110. In another implementation, the computer system 500 may be each of the member devices 140A-140Z.

In certain implementations, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., random access memory (RAM)), a non-volatile memory 506 (e.g., read-only memory (ROM) or electrically-erasable programmable ROM (EEPROM)), and a data storage device 516, which may communicate with each other via a bus 508.

Processing device 502 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 may further include a network interface device 522. Computer system 500 also may include a video display unit 510 (e.g., an LCD), an alphanumeric input device 512 (e.g., a keyboard), a cursor control device 514 (e.g., a mouse), and a signal generation device 520.

Data storage device 516 may include a non-transitory computer-readable storage medium 524 on which may store instructions 526 encoding any one or more of the methods or functions described herein, including instructions implementing the content management platform 113 of FIG. 1 for implementing the methods described herein.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “displaying”, “moving”, “adjusting”, “replacing”, “determining”, “playing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications frog a server. In addition, certain data may be treated in one or more ways before it is stored or used, so that personally identifiable information is removed. For example, a user's identity may be treated so that no personally identifiable information can be determined for the user, or a usographic location may be generalized where location information is obtained (such as to a city, ZIP code, or state level), so that a particular location of a user cannot be determined. Thus, the user may have control over what information is collected about the user, how that information is used, and what information is provided to the user.

What is claimed is:

1. A method for expanding a knowledge graph covering organization-specific content comprising:
identifying a knowledge graph comprising a plurality of nodes representing a plurality of defined terms;
scanning a plurality of communications from a plurality of sources of an organization to identify a plurality of frequently appearing terms;
determining which of the plurality of frequently appearing terms are not included in the plurality of defined terms of the knowledge graph to produce a set of undefined frequently appearing terms;
prompting one or more members of the organization to provide a definition for each undefined frequently appearing term from the set of undefined frequently appearing terms, wherein the prompting occurs without a user input; and
expanding the knowledge graph by adding one or more undefined frequently appearing terms, each having a provided definition, to the knowledge graph.

2. The method of claim 1, wherein the identified knowledge graph represents a dictionary of terms specific to at least one of an industry, a topic, a product of the organization or a service area of the organization.

3. The method of claim 1, wherein the scanning of the plurality of communications of the plurality of sources of the organization to identify the plurality of frequently appearing terms comprises:
determining a frequency of a term appearing in the plurality of communications from the plurality of sources;
determining a number of sources the term appears in;
calculating a frequency score of the term based on the frequency of the term and the number of sources; and
determining that the term having the frequency score above a predetermined threshold is a frequently appearing term.

4. The method of claim 3, wherein the calculating of the frequency score of the term comprises:
multiplying the frequency of the term by a first weight and multiplying the number of sources by a second weight.

5. The method of claim 4, wherein the frequency of the term and the number of sources are determined over a predefined time period.

6. The method of claim 4, wherein the calculating of the frequency score of the term is further based on at least one or more of a level of semantic relevance of a term to a respective communication, or a number of members using the term in the plurality of communications from the plurality of sources and an expertise of each member.

7. The method of claim 6, wherein the calculating of the frequency score of the term further comprises:
adjusting the first weight on the frequency of the term in proportion to the level of semantic relevance of the term.

8. The method of claim 6, wherein the calculating of the frequency score of the term further comprises:
adjusting the second weight on the number of sources in proportion to the number of members using the term in the plurality of communications from the plurality of sources.

9. The method of claim 1, wherein the plurality of sources of the organization comprises a plurality of services for communication and collaboration among members of the organization.

10. The method of claim 9, wherein the plurality of services for communication and collaboration comprises one or more of:
a document service;
a cloud-based storage service;
a social network service;
an email service;
a calendar service;
a search engine service;
a video conference service;
a media streaming service;
a news providing service; or
a photo management service.

11. The method of claim 1, the plurality of communications of the plurality of sources of the organization comprises one or more of:
text documents;
spreadsheet documents;
presentation documents;
emails;
instant messages;
social posts;
comments;
search queries;
voice or video calls;
videos;
songs;
calendar invitations; or
photographs.

12. The method of claim 1, wherein the prompting of the one or more members of the organization to provide the definition for each undefined frequently appearing term comprises:
identifying the one or more members of the organization for each undefined frequently appearing term based on one or more of expertise, responsiveness, or history of providing definitions of a member; and
sending a request to the identified one or more members of the organization to provide a definition to each undefined frequently appearing term.

13. The method of claim 12, wherein the sending of the request to the identified one or more members of the organization comprises:
monitoring communications of the identified one or more members of the organization via the plurality of sources of the organization to detect any terms in the set of undefined frequently appearing terms in the communications;
responsive to detecting a term, highlighting the term in the communications; and
prompting a respective member to provide a definition of the term.

14. The method of claim 12, wherein the sending of the request to the identified one or more members of the organization comprises:
adding a post with a question about a definition of each undefined frequently appearing term to a stream of a respective identified member on a periodic basis.

15. The method of claim 1, further comprising:
detecting a new communication of a member of the organization;
determining one or more terms from the expanded knowledge graph that are relevant to the new communication;
suggesting a tag including the determined one or more terms to the member; and
upon receiving an approval of the tag by the member, assigning the approved tag to the new communication.

16. The method of claim 15, wherein the determining of the one or more terms from the expanded knowledge graph that are relevant to the new communication is based on a content of the new communication and i) one or more profile attributes of the member, or ii) profile attributes of other members associated with the new communication.

17. The method of claim 16, wherein the profile attributes indicate at least one of an interest, an expertise, or an affinity of a respective member.

18. The method of claim 17, further comprising:
matching the assigned tag of the new communication with profile attributes of other members to identify one or more other members that are interested in the new communication; and
sending a notification of the new communication to each of the identified one or more other members.

19. The method of claim 18, wherein the matching of the assigned tag of the new communication with the profile attributes of other members comprises:
providing the assigned tag of the new communication and profile attributes of other members as an input to a machine learning model; and
obtaining an output from the machine learning model, the output indicating a level of relevancy of the new communication to a subset of other members, wherein
the machine learning model is trained by providing training data to the machine learning model on a set of training inputs and a set of training outputs, wherein:
the set of training inputs comprises one or more of communication attributes of communications, tags of communications, and profile attributes of members; and
the set of target outputs comprises an indication of whether or not a member has shown interest in the tag.

20. The method of claim 18, wherein the notification is included in at least one of:
a stream of a respective member;
an email to the respective member; or
a text message to the respective member.
